(19) United States
(12) Patent Application Publication
(10) Pub. No.: US 2015/0195669 A1
(43) Pub. Date: Jul. 9, 2015

(54) METHOD AND SYSTEM FOR A HEAD UNIT TO RECEIVE AN APPLICATION

(71) Applicant: Ford Global Technologies, LLC, Dearborn, MI (US)

(72) Inventors: Joey Ray GROVER, Madison Heights, MI (US); Philip Joseph DANNE, Royal Oak, MI (US); Scott SMEREKA, Warren, MI (US); Joel FISCHER, Royal Oak, MI (US)

(73) Assignee: Ford Global Technologies, LLC, Dearborn, MI (US)

(21) Appl. No.: 14/148,217

(22) Filed: Jan. 6, 2014

(51) Int. Cl. H04W 4/00; H04M 1/725; H04B 1/38

(52) U.S. Cl. CPC H04W 4/003; H04B 1/38; H04M 1/72522

(57) ABSTRACT

In one embodiment, a system including at least one controller in communication with one or more transceivers. The one or more transceivers are capable of communication with a device. The at least one controller configured to transmit a request for applications compatible with the at least one controller from the device based on a system identification code. The controller is further configured to receive the application list from the device based on the system identification code and output the application list at a user interface display. The output includes at least one of an icon and a description. The controller is further configured to transmit a request to launch an application based on the selection of the icon at the user interface display and receive the application data. The controller is further configured to output the application data at the user interface display.

### TECHNICAL FIELD

The present disclosure generally relates to vehicle infotainment systems, and more particularly, to systems and methods using applications on mobile devices in infotainment systems.

### BACKGROUND

U.S. Pat. No. 7,324,833 generally discloses a system incorporating teachings of an electronic device having a display, a memory, an audio file player, and a housing component at least partially defining a cavity in which the memory and the audio file player are secured. The electronic device may be a portable MP3 player. The system may also include a processor or playlist engine that can maintain a first playlist and a second playlist. In practice, the first playlist may include a selection of audio content having a corresponding audio file saved in the memory of the electronic device. The system may also include an automobile having an automobile sound system that has a speaker and an in dash sound system component, which may be removably coupled to the electronic device via a cable. The in dash sound system component may have a selector, which may be, for example, a button, that allows a user to select the first playlist for outputting via the speaker. The cable interconnecting the electronic device and the in dash sound system component may be capable of providing power to the electronic device in addition to communicatively coupling the electronic device to the automobile sound system.

U.S. Pat. No. 8,346,310 generally discloses a vehicle-based computing apparatus including a computer processor in communication with persistent and non-persistent memory. The apparatus also includes a local wireless transceiver in communication with the computer processor and configured to communicate wirelessly with a wireless device located at the vehicle. The processor is operable to receive, through the wireless transceiver, a connection request sent from a nomadic wireless device, the connection request including at least a name of an application seeking to communicate with the processor. The processor is further operable to receive at least one secondary communication from the nomadic device, once the connection request has been processed. The secondary communication is at least one of a speak alert command, a display text command, a create phrase command, and a prompt and listen command.

U.S. Patent Application 2012/096404 generally discloses an application included in a smartphone, an identifier, such as a name of the smartphone application, and information on whether the smartphone application operates in cooperation with a vehicle-mounted device, are registered in a smartphone application management table. From the smartphone applications included in the connected smartphone, higher priority is given to the smartphone applications that are registered in the smartphone application management table as applications that operate in cooperation with the vehicle-mounted device. A lower priority is given to other smartphone application. Icons of the high priority smartphone applications are arranged on a first page of a smartphone application menu, whereas icons of the low priority smartphone applications are sequentially arranged on second and following pages.

U.S. Patent Application 2013/137415 generally discloses a system that links a mobile device with a vehicle on-board unit. The system includes a data control section that restricts use of at least one of a plurality of registered application software products provided on the mobile device. The system includes a data output section that outputs an indication representing the at least one registered application software product to a display section of the vehicle on-board unit when the at least one application software product is available according to conditions of the vehicle.

### SUMMARY

In a first illustrative embodiment, a system including at least one controller in communication with one or more transceivers. The one or more transceivers capable of communication with a device. The at least one controller configured to transmit a request for applications compatible with the at least one controller from the device based on a system identification code. The controller is further configured to receive the application list from the device based on the system identification code and output the application list at a user interface display. The output includes at least one of an icon and a description. The controller is further configured to transmit a request to launch an application based on the selection of the icon at the user interface display and receive the application data. The controller is further configured to output the application data at the user interface display.

In a second illustrative embodiment, a device comprising at least one controller in communication with one or more transceivers. The one or more transceivers are capable of communication with a vehicle computing system and a server. The at least one controller is configured to receive a request for an application list compatible with the vehicle computing system. The at least one controller is further configured to transmit the request to the server and receive the application list from the server. The at least one controller is further configured to transmit the application list to the vehicle computing system.

In a third illustrative embodiment, a computer-program product embodied in a non-transitory computer read-able medium that is programmed for transmitting mobile device application data to a vehicle computing system for at least one of audio playback and display. The computer-program product comprising instructions for receiving a request for an application list compatible with the vehicle computing system based on a system identification code. The computer-program product further comprising instructions for transmitting the system identification code to a server and receiving the application list from the server. The computer-program product further comprising instructions for transmitting the application list to the vehicle computing system.

### BRIEF DESCRIPTION OF THE DRAWINGS

FIG. 1 is an exemplary block topology of a vehicle infotainment system implementing a user-interactive vehicle information display system according to an embodiment;

FIG. 2 is an exemplary block topology of a system for integrating one or more connected devices with the vehicle based computing system according to an embodiment;

FIG. 3 is a block diagram illustrating a computing system in communication with a connected device according to an embodiment;

FIG. 4 is a block diagram illustrating an example method of a computing system managing, displaying, and executing applications received from a device according to an embodiment;

FIG. 5 is a flow chart illustrating an example method of a computing system communicating with a device according to an embodiment;

FIG. 6 is a flow chart illustrating an example method of a device communicating with a computing system providing applications according to an embodiment; and

FIG. 7 is a flow chart illustrating an example method of a server communicating with a device providing applications according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

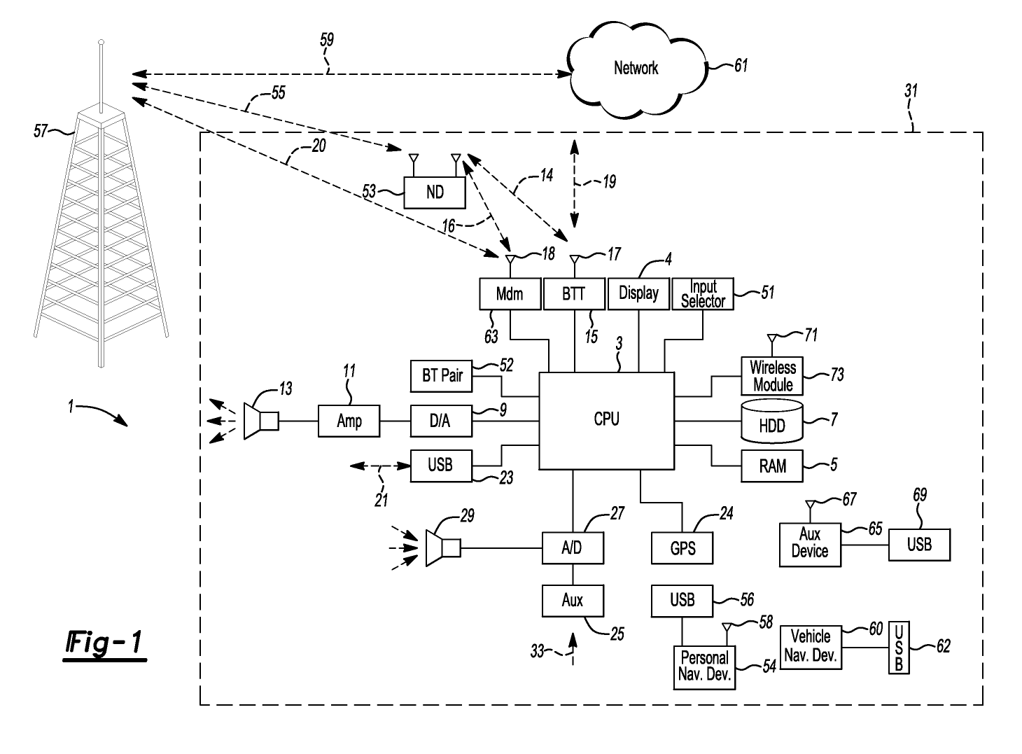

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

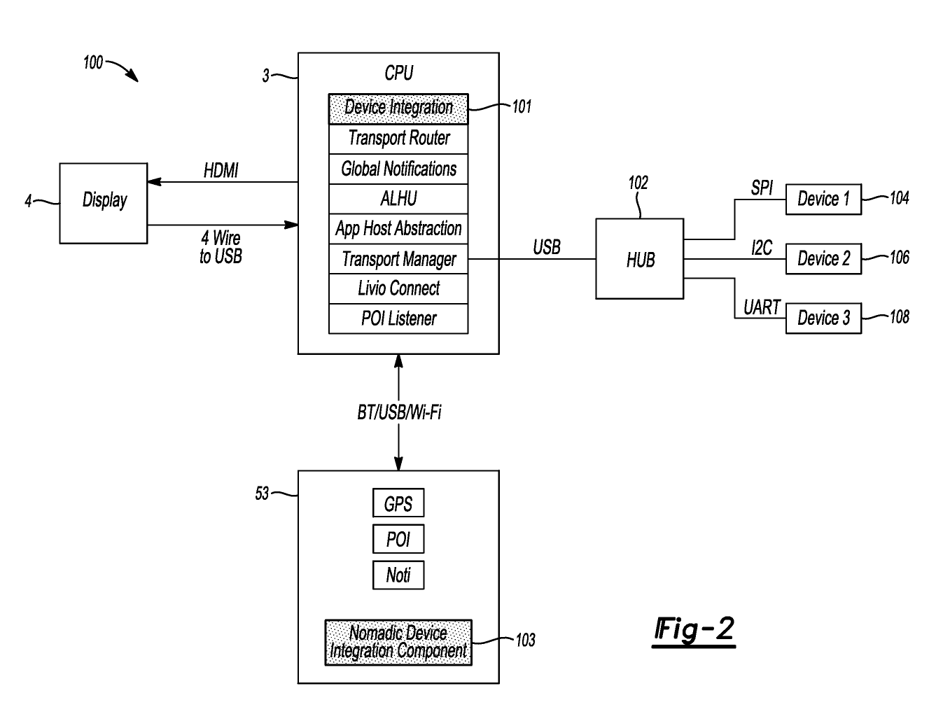

FIG. 2 is an exemplary block topology of a system 100 for integrating one or more connected devices with the vehicle based computing system 1 (VCS). The CPU 3 may be in communication with one or more transceivers. The one or more transceivers are capable for wired and wireless communication for the integration of one or more devices. To facilitate the integration, the CPU 3 may include a device integration framework 101 configured to provide various services to the connected devices. These services may include transport routing of messages between the connected devices and the CPU 3, global notification services to allow connected devices to provide alerts to the user, application launch and management facilities to allow for unified access to applications executed by the CPU 3 and those executed by the connected devices, and point of interest location and management services for various possible vehicle 31 destinations.

As mentioned above, the CPU 3 of the VCS 1 may be configured to interface with one or more nomadic devices 53 of various types. The nomadic device 53 may further include a device integration client component 103 to allow the nomadic device 53 to take advantage of the services provided by the device integration framework 101.

The one or more transceivers may include a multiport connector hub 102. The multiport connector hub 102 may be used to interface between the CPU 3 and additional types of connected devices other than the nomadic devices 53. The multiport connector hub 102 may communicate with the CPU 3 over various buses and protocols, such as via USB, and may further communicate with the connected devices using various other connection buses and protocols, such as Serial Peripheral Interface Bus (SPI), Inter-integrated circuit (I2C), and/or Universal Asynchronous Receiver/Transmitter (UART). The multiport connector hub 102 may further perform communication protocol translation and interworking services between the protocols used by the connected devices and the protocol used between the multiport connector hub 102 and the CPU 3. The connected devices may include, as some non-limiting examples, a radar detector 104, a global position receiver device 106, and a storage device 108 and those executed by the connected devices, and point of interest loction and management services for various possible vehicle 31 destinations (e.g., Application Launch Helper Unit used as a service that may include transport routing of messages between the connected devices and the CPU 3).

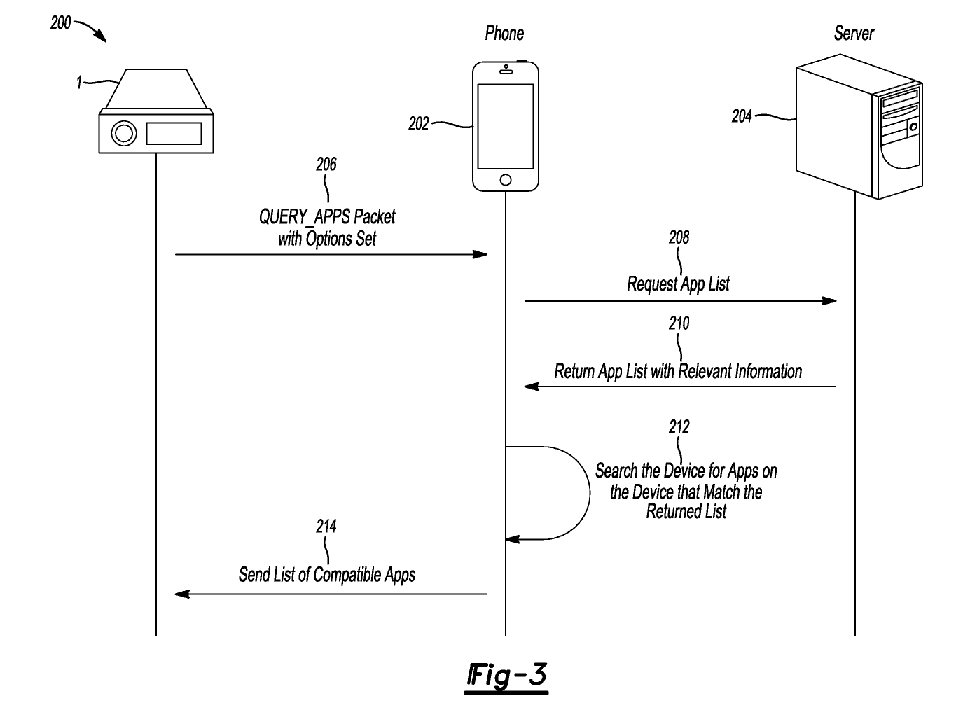

FIG. 3 is a block diagram 200 illustrating the vehicle computing system 1 in communication with one or more devices 202, according to an embodiment. The VCS 1 may receive identification requests from the device 202. The device 202 may transmit an identification request once the VCS 1 is detected. The identification request may include, but is not limited to, requesting if the device 202 is compatible with the VCS 1, and if the system has an application/service that may depend on the device 202.

For example, the VCS 1 may have one or more applications stored in local memory, but may not choose to output the application icon/description at the display 4 because the one or more applications may require an external data source (e.g., device) to be connected with the VCS 1 for execution of the feature/function. In another example, the system may have a navigation application stored in memory, however the VCS 1 may not allow a user to launch the application until the global position receiver device is present and connected with the system.

The VCS 1 may respond to the identification request and transmit an answer to the device 202. The answer may include, but is not limited to, a message notifying the device 202 is not compatible with the VCS 1, or a message notifying the device 202 is compatible with the VCS 1 and what application(s) and/or services that may be enabled by the VCS 1. The VCS 1 may request a query of applications 206 (QUERY_APPS) that may be available for implementation on the VCS 1. The request to query applications 206 available may also include an identification code associated with the VCS 1. The identification code may be used to allow the device to determine what applications are compatible with the VCS 1.

For example, the identification code may contain several identifiers describing one or more build specification of the VCS 1 including, but not limited to, hardware configuration, software version(s), user interface displays, and/or firmware version(s). The compatible applications may include applications that may be able to be executed by the VCS 1 based on the version of software, version of firm, hardware configuration, and/or a combination thereof.

The device may receive the request to query what applications are compatible with the VCS 1 based on the identification code associated with the system. The device may perform a query of the applications stored on its memory to determine which are compatible with the VCS 1. The device may also transmit a request application list message 208 to a server 204 to retrieve a list of applications compatible with the VCS 1. The request application list message 208 to the server includes the VCS 1 identification code.

The server 204 may receive the request application list message 208 from the device 202 and execute a query to determine a compatible application list based on the VCS 1 identification code. The server 204 may transmit an application list with relevant information 210 to the device 202. The relevant information may include, but is not limited to, a short description and/or an icon of the application(s) in the compatible application list.

The device 202 may receive the application list with relevant information 210 from the server 204, and search for applications 212 on the device 202 that match the applications on the list. The device may transmit an application list of available applications 214 on the device that is compatible with the VCS 1 based on the received list from the server 204.

For example, once communication has been established between the VCS 1 and device 202, the VCS 1 may transmit a request to query applications available based on the identification code associated with the VCS 1. The device 202 may communicate with a server 204 to determine a list of available applications that are compatible with the VCS 1. The device may receive this list of available applications from the server. The device 202 may compare the applications it has stored to the list of available applications received from the server 204 that are compatible with the VCS 1. The device 202 may transmit to the VCS 1 the list of compatible applications it has stored. In another example, the device 202 may transmit the entire application list of compatible applications form the server 204 to the VCS 1. The VCS 1 may allow a user to request a compatible application to be downloaded at the device 202 from the server 204 if it is not already stored at the device 202.

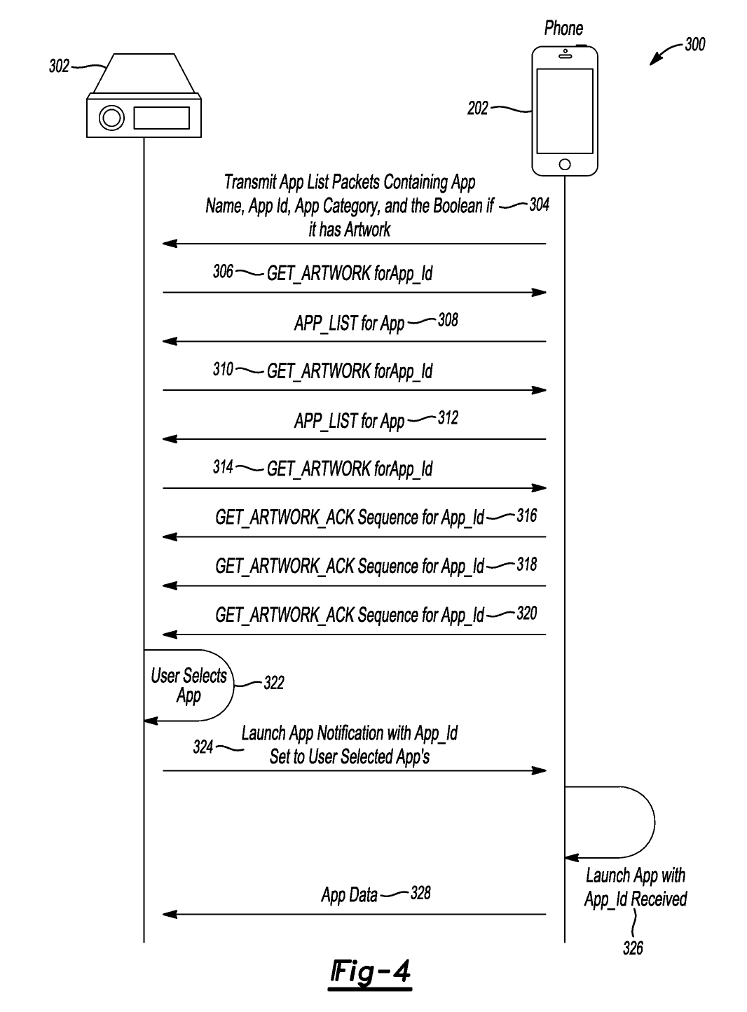

FIG. 4 is a block diagram illustrating an example method 300 of a vehicle computing system (VCS) 1 managing, displaying, and executing applications received from a device 202 according to an embodiment. The VCS 1 may receive a request to connect from one or more devices 202. The devices 202 may include, but is not limited to, a smart phone, a radar detector, a global position receiver device, tablet, and a storage device.

The VCS 1 may receive a list of compatible applications from a device 202. The device 202 may transmit compatible application list data 304 to the VCS 1 which may include, but is not limited to, an application name, application identification, application category, and a notification if the application has artwork. The VCS 1 may request to retrieve the application artwork 306 (GET_ARTWORK for App_Id) for one or more compatible applications.

The device 202 may continuously communicate to the VCS 1 an updated application list 304, 308 GET-LIST for App), 312 GET-LIST for App) including one or more mobile applications that may be compatible with the system. The VCS 1 may continuously request artwork 306, 310 (GET_ARTWORK for App_Id), 314 (GET_ARTWORK for App_Id) regarding the one or more mobile applications being received by the device 202. The device 202 may transmit the requested artwork 316 (GET_ARTWORK_ACK Sequence for App_Id), 318, 320 (GET_ARTWORK_ACK Sequence for App_Id) to the VCS 1.

The VCS 1 may output the application list with the respective artwork at a user interface display 4. The one or more applications outputted at a user interface display 4 may be selected 322 for implementation/execution at the VCS 1. The VCS 1 may transmit a launch request 324 based on the one or more applications selected for implementation/execution at the user interface display 4. The device 202 may determine if the application is stored at the device's storage memory, and/or if the device 202 may need to download the requested application from a server 204.

The device 202 may launch the application 326 and transmit the application data 328 to the VCS 1. For example, if the demanded application being requested by the VCS is not available at the device 202, the device 202 may transmit a message to a server 204 requesting to download the application being demanded for launch by the VCS 1.

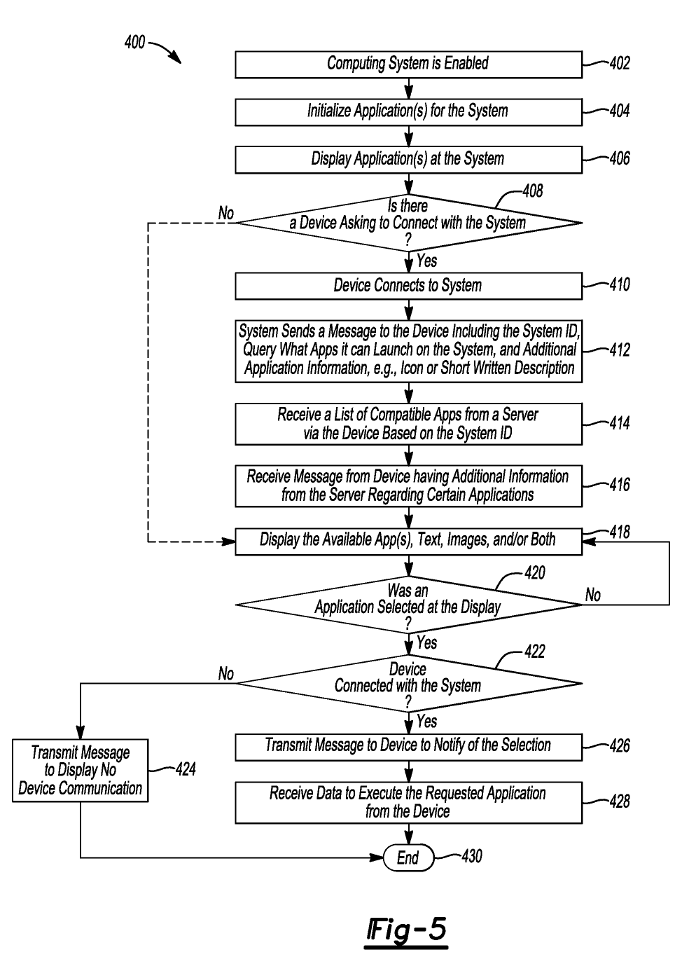

FIG. 5 is a flow chart illustrating an example method of a vehicle computing system (VCS) 1 communicating with a device according to an embodiment. The method 400 may be implemented using software code contained within the VCS 1. In other embodiments, the method 400 may be implemented in other vehicle controllers, or distributed amongst multiple vehicle controllers.

Referring again to FIG. 5, the vehicle and its components illustrated in FIG. 1, FIG. 2, FIG. 3, and FIG. 4 are referenced throughout the discussion of the method to facilitate understanding of various aspects of the present disclosure. The method 400 of recognizing a compatible feature/function/service applications while communicating with one or more devices 202 may be implemented through a computer algorithm, machine executable code, or software instructions programmed into a suitable programmable logic device(s) of the vehicle, such as the vehicle control module, the device control module, another controller in communication with the vehicle computing system, or a combination thereof. Although the various operations shown in the flowchart diagram 400 appear to occur in a chronological sequence, at least some of the operations may occur in a different order, and some operations may be performed concurrently or not at all.

In operation 402, the VCS 1 may be enabled by a start request received from one or more mechanisms including, but not limited to, a vehicle key, a vehicle key fob, a wireless device, and/or a combination thereof. The VCS 1 may initialize one or more applications for execution in operation 404.

The In operation 406, the VCS 1 may output one or more applications at a display 4 in communication with one or more controllers configured within the system. The VCS 1 may store, but choose not to display, one or more applications which may require an external data source to be present for launch and/or execution. The VCS 1 may search for one or more devices 202 requesting to connect with the system in operation 408. If the VCS 1 detects no device 202 asking to connect, the system may continue to output to the display 4 the applications initialized in operation 418. If a device is detected, the VCS 1 may attempt to connect using a communication link with the device in operation 410. The communication link may include wireless communication technology (e.g., Bluetooth, Bluetooth low energy, WiFi, etc.) and/or a wired connection (e.g., USB, SPI, UART, etc.).

In operation 412, the VCS 1 may send a message to the device 202 requesting the available applications compatible with the VCS 1. The message may include, but is not limited to, a system identification code that identifies the maker, model, and/or software associated with the VCS 1. The system identification code may be used to identify the applications that may be compatible with the VCS 1.

In operation 414, the VCS 1 may receive an application list of compatible applications from a remote server via the one or more devices 202 including application icon(s) and/or a description of the compatible application(s) based on the system identification. The VCS 1 may transmit the application(s) icon and/or description of the compatible application(s) for output at the display 4.

In operation 416, the VCS 1 may receive one or more messages from the server 204 via the device 202 which may include additional information regarding the one or more compatible applications. The additional information may include, but is not limited to, application category, application artwork, and/or an updated version of the application available for download. The VCS 1 may display the available application(s) text, images (e.g. icon artwork), and/or a combination of both in operation 418.

In operation 420, the VCS 1 may monitor to see whether an application has been selected at the user interface display 4 for launch/operation. For example, a user may select the launch of one or more applications by using a touch screen interface, voice commands, steering wheel controls, and/or a combination thereof. If the application was selected for execution, the VCS 1 may determine if the device (e.g., external source) is connected with the system in operation 422. If the VCS 1 determines that the device needed to execute the selected application is not selected or has lost connection, a message may be output to notify that the device is disconnected in operation 424.

In operation 426, if the device is connected with the VCS 1, the system may transmit a message to the device 202 notifying of the request to launch the application. The VCS 1 may receive data to execute the requested application for output in operation 428. The system may receive a disable request from one or more sources including, but not limited to, a key-off message received from the one or more mechanisms, a message to disable the application from the device, and/or received input at a user interface 4 to disable the application in operation 430.

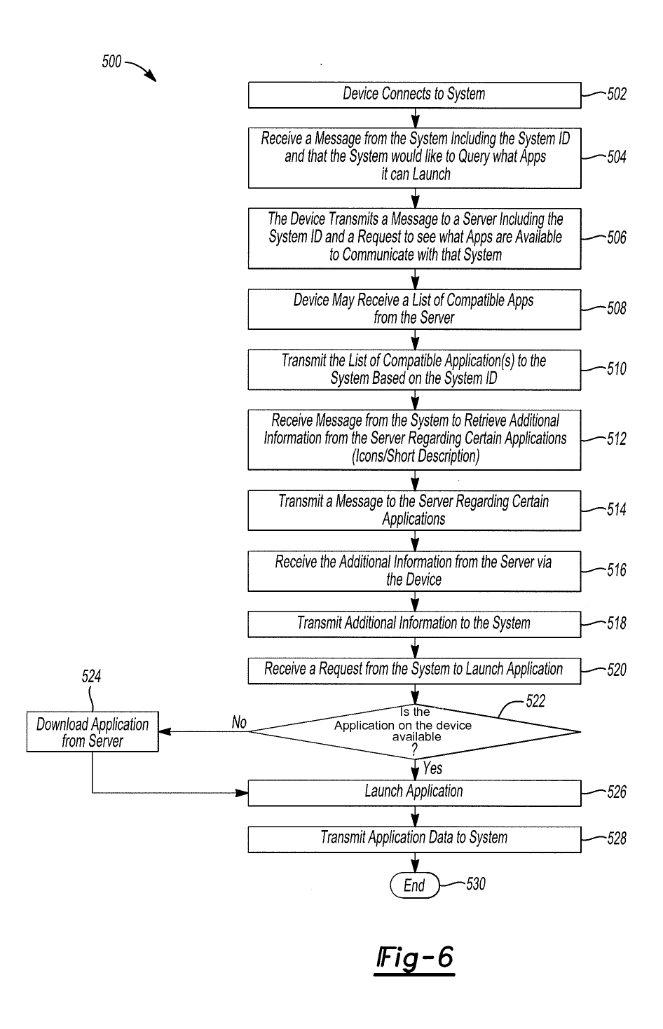

FIG. 6 is a flow chart illustrating an example method 500 of a device 202 communicating with a vehicle computing system (VCS) 1 providing applications according to an embodiment. The device 202 may include, but is not limited to, at least one controller, one or more transceivers, and/or a user interface. The one or more transceivers may communicate using wireless and/or wired technology. The wireless technology may include, but is not limited to, WiFi, Bluetooth, and/or Bluetooth low energy. The wired technology may include, but is not limited to, USB, SPI, and/or UART.

In operation 502, the device may detect the presence of the VCS 1 using wireless and/or wired technology, and transmit a request to connect to the system. The device may connect to the system by sending over a message which may include, but is not limited to, the device identification. The device may receive a message form the VCS 1 which may include, but is not limited to, a system identification code and a request to query what applications the device may execute based on the system identification code in operation 504. The system identification code may be a unique code used to identify several characteristics of the VCS 1 including, but not limited to, the software version, firmware version, hardware version, and/or other system identifiers.

In operation 506, the device may transmit a message to a server which may include the system identification code and a request to query what applications are available to launch with the VCS 1. The device 202 may receive a list of compatible applications from the server 204 based on the system identification code in operation 508.

For example, if the VCS 1 is based on a model year that included a software version that was only compatible with a selected variety of mobile applications, the server may determine the VCS 1 build information using the system identification code and retrieve the selected variety of mobile applications compatible with the system.

In operation 510, the device 202 may transmit the list of compatible application(s) from the server 204 to the VCS 1. The device 202 may receive a message form the VCS 1 to retrieve additional information form the server 204 regarding certain application which may include, but is not limited to, icon artwork, short description of the application, and/or a combination of both in operation 512. In another embodiment, the icon and/or short description of the application may be initially sent to the VCS 1 with the initial list of compatible applications message.

In operation 514, the device may transmit a message to the server requesting additional information certain applications. The device may receive the additional information form the server in operation 516.

In operation 518, the device may transmit the additional information to the VCS 1. The device may receive a request form the VCS 1 to launch an application in operation 520. The device may run a query to determine if the application is available on the device in operation 522.

In operation 524, if the application is not available at the device or there is a latest version that is compatible with the VCS 1, the device may download the application being requested to launch form the server. If the application is available at the device and/or it has been successfully downloaded from the server, the device may launch the application in operation 526.

In operation 528, the device may transmit the application data to the VCS 1. The application data may be transmitted to the VCS 1 using wireless and/or wired technology. The data may continuously be transmitted until a disable request is received by the VCS 1 in operation 530.

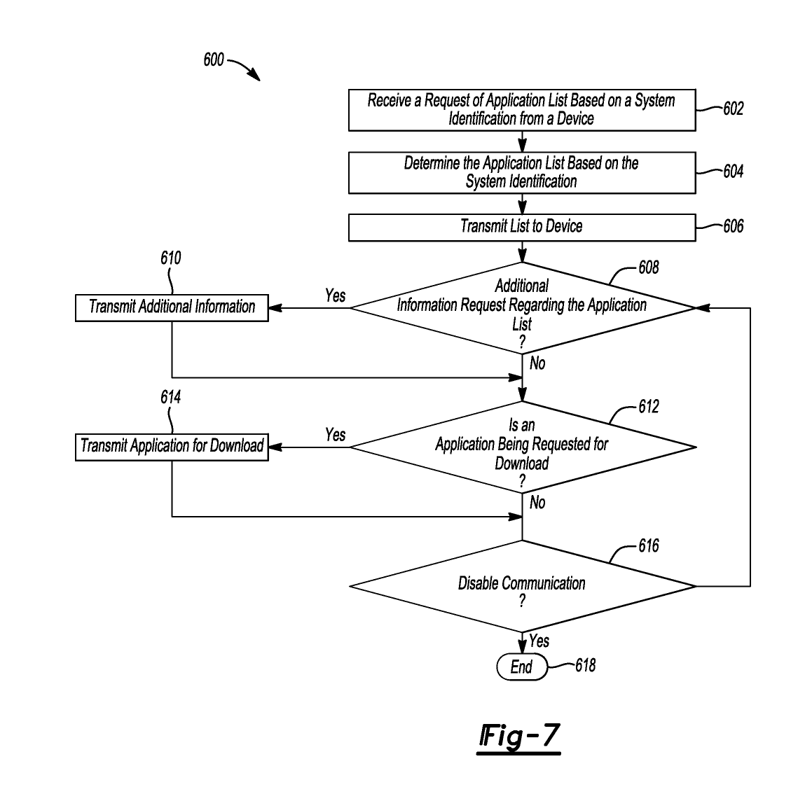

FIG. 7 is a flow chart illustrating an example method 600 of a server communicating with a device providing applications according to an embodiment. The device may be capable of communicating with one or more transceivers. A controller is configured with the one or more transceivers to enable the device 202 of processing the request received from the VCS 1 and transmitting the request to the server 204. The server 204 may provide a database of available applications for one or more devices related to several vehicle computing system configurations that may be communicated via wireless communication.

In operation 602, a server 204 may receive a request for an application list based on a system identification code from a device 202. The server may determine the applications that are compatible with the VCS 1 based on the system identification code in operation 604.

In operation 606, the server 204 may transmit the list of applications compatible with the device and/or the VCS 1 to the device 202. The server may receive a request for additional information regarding one or more applications on the list of compatible applications in operation 608.

In operation 610, if the server receives a request for additional information, the server may transmit the additional information to the device. The server may receive a request to download an application at the device in operation 612. If the server receives a request to download an application, the server may transmit data that allows the device to download an application at step 614.

In operation 616, the server may continuously communicate with the device until a disable request is received. The continuous communication may allow for data to be transmitted to the device while being presented at a VCS 1 user interface display 4. The data may continuously be transmitted until a disable request is received in operation 618.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system comprising:
at least one controller in communication with one or more transceivers, the one or more transceivers capable of communication with a device, the at least one controller configured to:
transmit a request for applications compatible with the at least one controller from the device based on a system identification code;
receive an application list from the device based on the system identification code;
output the application list at a user interface display, wherein the output includes at least one of an icon and a description;
transmit a request to launch an application corresponding to a selection of the icon or description at the user interface display;
receive data from the selected application; and
output the data at the user interface display.

2. The system of claim 1, wherein the applications compatible with the at least one controller includes an application that is executable based on at least one of software version and hardware configuration on the at least one controller.

3. The system of claim 1, wherein the one or more transceivers are capable of wireless communication and wired communication.

4. The system of claim 3, wherein the wireless communication and wired communication includes at least one of Bluetooth, Bluetooth low energy, Near Field Communication, WiFi, Serial Peripheral Interface Bus, Inter-Integrated circuit, and Universal Asynchronous Receiver/Transmitter.

5. The system of claim 1, wherein the at least one controller is further configured to transmit a request to download an application based on the selection of the icon at the user interface display.

6. The system of claim 5, wherein the request to download the application is transmitted to a server via the device.

7. The system of claim 5, wherein the request to download the application may be stored in memory at least one of VCS and device.

8. A device comprising:
at least one controller in communication with one or more transceivers, the one or more transceivers are capable of communication with a vehicle computing system (VCS) and a server, the at least one controller configured to:
receive a request for an application list compatible with the VCS;
transmit the request to the server;
receive the application list from the server; and
transmit the application list to the VCS.

9. The device of claim 8, wherein the application list compatible with the VCS includes an application that is executable based on at least one of software version, firmware version and hardware configuration on the VCS.

10. The device of claim 8, wherein the at least one controller is further configured to:
receive a request to launch an application from the VCS; and
transmit application data to the VCS.

11. The device of claim 10, wherein the at least one controller is further configured to:
in response to the request to launch the application, the device determines if the application is stored in local memory;
if the application is not in local memory, request to download the application from the server; and
receive the application from the server.

12. The device of claim 11, wherein the at least one controller is further configured to launch the application at the device; and transmit the application data to the VCS.

13. The system of claim 8, wherein the one or more transceivers are capable of wireless communication and wired communication.

14. The system of claim 13, wherein the wired communication includes at least one of Serial Peripheral Interface Bus, Inter-Integrated circuit, and/or Universal Asynchronous Receiver/Transmitter.

15. A computer-program product embodied in a non-transitory computer read-able medium that is programmed for transmitting mobile device application data to a vehicle computing system (VCS) for at least one of audio playback and display, the computer-program product comprising instructions for:
receiving a request for an application list compatible with the VCS based on a system identification code;
transmitting the system identification code to a server;
receiving the application list from the server; and
transmitting the application list to the VCS.

16. The computer-program product of claim 15, wherein the non-transitory computer read-able medium comprising further instructions to:
receiving a request to launch an application from the VCS; and
transmitting application data to the VCS.

17. The computer-program product of claim 16, wherein the non-transitory computer read-able medium comprising further instructions to:
in response to the request to launch the application, the device is determining if the application is stored in local memory;
if the application is not in local memory, requesting to download the application from the server; and
receiving the application from the server.

18. The computer-program product of claim 17, wherein the non-transitory computer read-able medium comprising further instructions to launching the application at the device; and transmitting the application data to the VCS.

19. The computer-program product of claim 15, wherein the transmitting mobile device application data is based on using one or more transceivers capable of wireless communication and wired communication.

20. The computer-program product of claim 19, wherein the wireless communication includes at least one of Bluetooth, Bluetooth low energy, Near Field Communication, and WiFi.
